(19) United States
(12) Patent Application Publication
(10) Pub. No.: US 2003/0164165 A1
(43) Pub. Date: Sep. 4, 2003

(54) Ignition system for an internal combustion engine

(76) Inventors: Horst Meinders, Reutlingen (DE); Wolfgang Feiler, Reutlingen (DE)

Correspondence Address: KENYON & KENYON, ONE BROADWAY, NEW YORK, NY, 10004, US

(21) Appl. No.: 10/258,935

(22) PCT Filed: Mar. 15, 2001
(86) PCT No.: PCT/DE01/00991

(30) Foreign Application Priority Data
Apr. 29, 2000 (DE) 10021170.4

(51) Int. Cl. F02P 1/00

(52) U.S. Cl. 123/644

(57) ABSTRACT

The present invention relates to an ignition system for an internal combustion engine having an ignition device that requires a high voltage (ignition voltage) for igniting the ignition spark.

Two ignition coils (14 and 16) are provided, whose secondary windings (20, 24) are each connected to electrodes (18, 22) of a spark plug (12, 12′), whose primary windings (28, 34) can be connected in each case by a switching means (30, 36) to a supply voltage source, and a drive circuit, via which the ignition coils (14, 16) are driven in a time-displaced manner.

The present invention relates to an ignition system for an internal combustion engine having the features cited in the preamble of claim 1.

### BACKGROUND INFORMATION

Ignition systems of the type of the species are known. They act to ignite a compressed fuel-air mixture in the internal combustion engine. For this purpose, using an ignition device, usually a spark plug, an arc discharge is generated between two electrodes of the spark plug. To generate this arc discharge, an ignition voltage in the high-voltage range is made available. To make available this necessary high voltage, it is known to connect the spark plug to the secondary winding of an ignition coil whose primary winding can be connected to a voltage source, which in motor vehicles is usually the motor vehicle battery. In this context, the ignition coil operates as an energy storage device and as a transformer. During the closing time of the primary-side switching means, the electrical energy made available from the voltage source is stored in the magnetic field of the ignition coil, and, at the ignition time point, it is made available as a high-voltage ignition pulse.

To ignite the compressed fuel-air mixture, a specific minimum ignition energy is necessary. The level of this minimum ignition energy is a function of the stochiometric composition of the fuel-air mixture. In particular, when the fuel-air mixture is lean, i.e., air is present in stochiometric excess, then an increased minimum ignition energy is necessary. If this minimum ignition energy is not made available, the result can be the incomplete combustion of the fuel-air mixture or ignition misfiring. The known options for influencing the combustion process lie in varying the spark duration and/or the spark current. To increase the spark duration and/or the spark current, it is known to increase in the ignition coil the energy that is stored on the primary side, for example, by increasing the primary current on the primary side. In this context, however, the disadvantage is met with that is necessary to select a correspondingly large design of an ignition coil. The stands in opposition to the goal of optimizing the installation volume.

### ADVANTAGES OF THE INVENTION

The ignition system according to the present invention having the features cited in claim 1 offers the advantage that it is possible in a simple manner to make available high ignition energy, which is adequately proportioned in every operating situation of the internal combustion engine, especially in igniting lean fuel-air mixtures. As a result of the fact that two ignition coils are provided, each of whose secondary winding is connected to one spark plug and whose primary windings can each be acted upon by a switching means using the supply voltage, and that a drive circuit is provided which makes possible a time-displaced driving of the switching means and therefore of the ignition coils, it is advantageously possible to switch on the second ignition coil precisely at the time point at which, in the voltage circuit of the first ignition coil, the switch-off voltage results in the secondary-side generation of the high voltage. In this manner, on the high-voltage side of the second ignition coil, a positive switch-on voltage arises, which is added to the negative spark voltage of the ignition spark generated by the first ignition coil, and therefore the spark voltage present at the ignition electrodes of the spark plug is increased, specifically, more than doubled. In this manner, a greater ignition spark duration and a higher ignition spark current are obtained, resulting generally in making available greater ignition energy. This high ignition energy is well-suited to reliably igniting even lean fuel-air mixtures every time. By connecting in alternating fashion the other ignition coil in the switch-off phase of the previously connected ignition coil, it is possible repeatedly to extend the spark duration over a longer time period.

Preferred embodiments of the present invention are indicated by the other features cited in the subclaims.

### DRAWINGS

The present invention is discussed in greater detail below in exemplary embodiments on the basis of the attached drawings. The following are the contents:

FIG. 1 schematically depicts an ignition system in a circuit diagram;

FIGS. 2 through 7 depict various characteristic curves of the ignition system, and

FIGS. 8 through 10 depict circuit diagrams of ignition systems in other embodiment variants.

### DESCRIPTION OF THE EXEMPLARY EMBODIMENTS

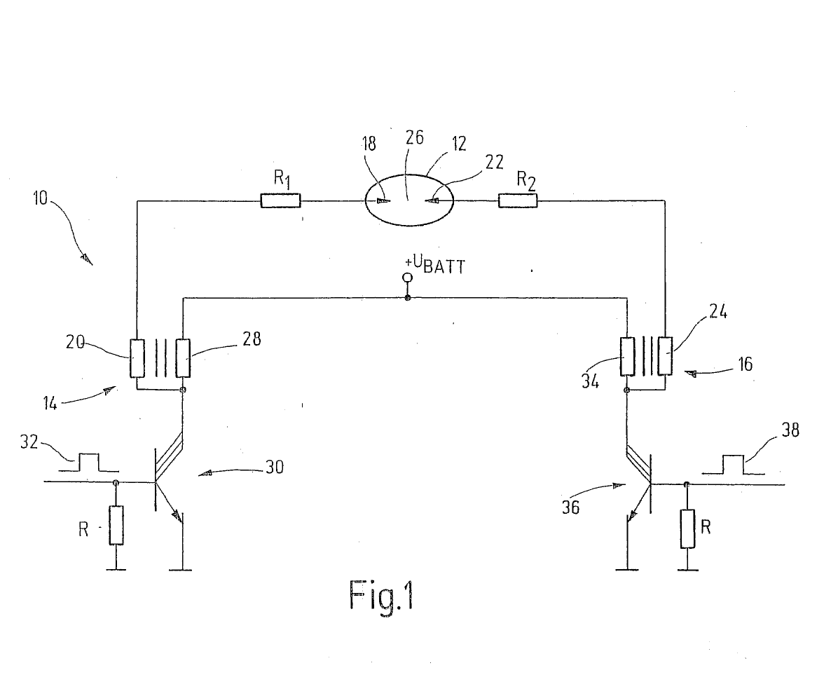

FIG. 1 depicts an ignition system, designated overall as 10, in a substitute circuit diagram. Ignition system 10 includes a spark plug 12, to which is assigned a first ignition coil 14 and a second ignition coil 16. One electrode 18 of ignition coil 12 is connected to secondary winding 20 of first ignition coil 14. Second electrode 22 of spark plug 12 is connected to secondary coil 24 of second ignition coil 16. Configured between electrodes 18 and 22 is an ignition gap 26. Connected between electrodes 18 and 22, and secondary coils 20 and 24, are resistor R₁ and R₂, respectively. Primary coil 28 of first ignition coil 14 is connected on one side to a supply voltage source U_{BATT}, in motor vehicles usually the motor vehicle battery. On the other side, primary winding 28 is connected to the secondary winding and a switching means 30. Switching means 30 is a three-phase Darlington transistor. Alternatively, secondary winding 20, via a switch-on suppression diode D, can also be connected at the anode to the secondary winding and at the cathode to ground. The emitter of switching means 30 contacts ground. The base of switching means 30 is connected to a drive circuit that is not depicted in any greater detail and is acted upon by a control signal 32 that is indicated here schematically. Primary winding 34 of second ignition coil 16 is also connected, on the one hand, to supply voltage source U_{BATT} and, on the other hand, to a switching means 36 which is also configured as a three-phase Darlington transistor. The emitter of switching means 36 contacts ground, whereas the base of switching means 36 is connected to the drive circuit and can be acted upon by a control signal 38.

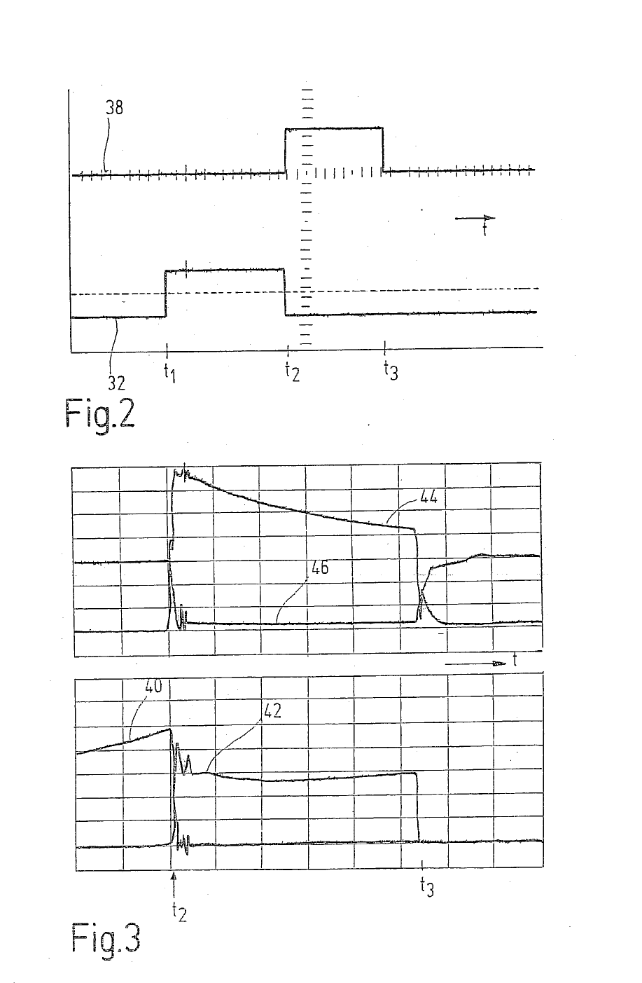

The functioning of ignition system 10 is discussed on the basis of characteristic curves that are depicted in FIGS. 2 through 9:

The design and function of ignition coils that are driven by Darlington ignition transistors and the generation of an ignition spark by these means are generally known, so that in the context of the present description only the exceptional points in accordance with the present invention will be discussed. Switching means 30 and 36 are driven by control signals 32 and 38, whose curve is depicted in FIG. 2. Control signals 32 and 38, in this context, are made available by the drive circuit in a time-displaced fashion. I.e., at the switch-off time point of control signal 32, i.e., when the latter falls from the level “high” to the level “low,” control signal 38 is connected, i.e., it rises from its level “low” to the level “high.” In this context, it can be provided that each of switching means 30 and 36 is acted upon by a control pulse, or switching means 30 and 36 are alternately acted upon by their control pulses 32, 38, respectively, the level “high” each time being time-displaced.

By having switching means 30 acted upon by control signal 32, the former is switched through during the switch-on period, so that primary coil 28 of first ignition coil 14 receives current. At the switch-off time point of switching means 30, there arises in the collector of switching means 30 a switch-off voltage (clamping voltage), which results in the induction of a high voltage at secondary coil 20. This high voltage is applied via resistor R₁ at electrode 18 and results in creating an ignition spark between electrodes 18 and 22 of spark plug 12. Precisely at this time point, switching means 36 is switched on by being driven by a control signal 38, so that primary coil 34 of second ignition coil 16 receives current. In this manner, in secondary winding 24 of second ignition coil 16, a positive switch-on voltage is induced, which is added to the negative spark voltage of the ignition spark that is generated by ignition coil 14. Thus the spark voltage applied at electrodes 18 and 22 is increased. The high voltage supplied by first ignition coil 14 is in the range of 800 V to 1200 V, whereas the positive switch-on voltage of the second ignition coil is in the range of 1200 V to 1700 V. Therefore, the spark voltage applied at electrodes 18 and 22 is more than doubled by connecting second switching means 36 and thus second ignition coil 16. As a result of this increased ignition voltage, the duration of the ignition spark and of the ignition spark current is increased, so that greater energy can be transferred in the arcing sparks.

When second ignition coil 16 is switched off, a spark voltage is generated, by analogy, that has the reversed polarity. If subsequently in the switch-off procedure of ignition coil 16, ignition coil 14 is connected in an analogous manner, then once again the positive switch-on voltage of first ignition coil 14 is added to the spark voltage of the new ignition spark.

In FIG. 3, the curve of the collector current of switching means 30 (characteristic curve 40), the collector current of switching means 36 (characteristic curve 42), the curve of the ignition current (characteristic curve 44) at spark plug 12, and the curve of the clamping voltage of switching means 30 (characteristic curve 46) are depicted.

On the basis of the characteristic curves, it is clear that via the high-voltage side of ignition coil 14 and the high-voltage side of ignition coil 16, which are connected in response to closing an ignition current, in primary winding 34 of second ignition coil 16 a voltage is induced which results in a current commutation at the primary side of ignition coil 16. This current commutation is brought about by suddenly igniting the ignition spark in primary winding 34, which previously had not received current, i.e., was cold. The slope of characteristic curve 42 makes clear that at switch-off time point t₂ of first switching means 30, the ignition spark ignites and therefore the commutated current flowing at primary winding 34 of ignition coil 16 abruptly rises at a steep slope, and it subsequently falls, in order to rise once again. This temporary falling of the current commutated at the primary side of ignition coil 16 derives from the heating of primary winding 34. Characteristic curve 40 makes clear that at switch-off time point t₂ of switching means 30, the charging current of ignition coil 14 falls. It is clear that, according to characteristic curve 40, the charging current in the primary circuit of ignition coil 14 slowly rises at a relatively flat charging slope, whereas in the primary circuit of ignition coil 16, the charging current—as discussed—rises sharply.

The ignition current at spark plug 12 (characteristic curve 44) rises suddenly to a maximum value when switching means 30 is switched off and falls over the duration of the ignition spark until time point t₃. At time point t₃, the primary circuit of ignition coil 16 is switched off, so that the arcing current flows in the opposite direction and initially falls to a negative maximum value, in order subsequently once again to rise to zero. The curve of the clamping voltage (characteristic curve 46) of switching means 30 makes clear the voltage jump at switch-off time point t₂, which results in igniting the ignition spark, and a voltage jump at time point t₃.

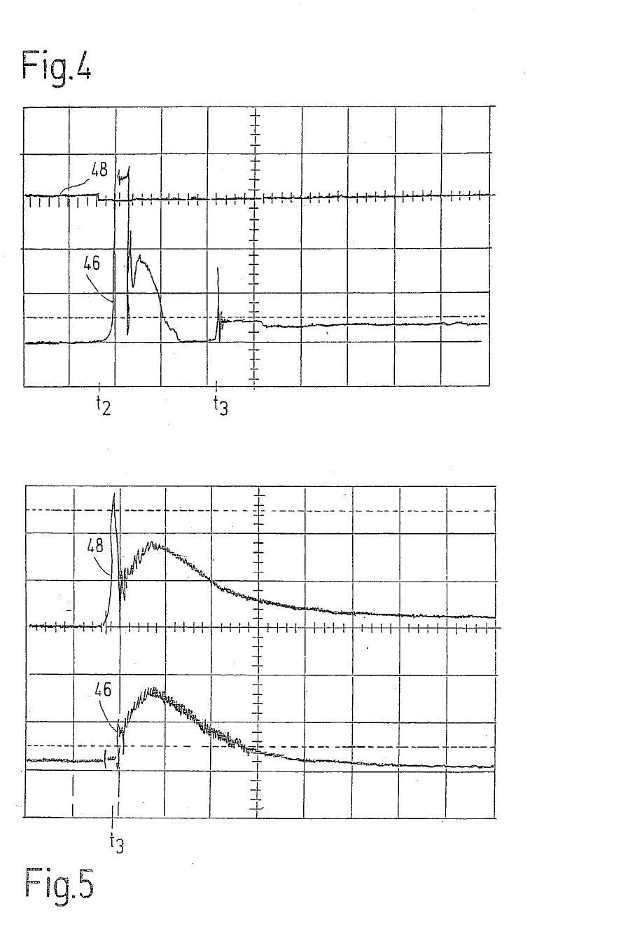

FIG. 4 once again depicts characteristic curve 46 (clamping voltage U_{CE}) of switching means 30. In addition, the curve of clamping voltage U_{CE} (characteristic curve 48) of switching means 36 is depicted. FIG. 5 shows the curve of clamping voltages U_{CE} of switching means 30 and 36, respectively, as of time point t₃. On the basis of FIGS. 4 and 5, it is clear that, according to characteristic curve 46 in FIG. 4, the rise of the clamping voltage at time point t₂ during the ignition of the ignition spark the subsequent feedback of the burning ignition spark onto primary winding 28, and a voltage spike at time point t₃, from which subsequently the clamping voltage sinks to the supply voltage. At time point t₃, the result is therefore a coupling vibration acting on primary coil 28 of ignition coil 14. Clamping voltage 48 of switching means 36 falls at time point t₂ from the supply voltage level to the saturation voltage level. At time point t₃, the clamping voltage of switching means 36 rises sharply, as characteristic curve slope 48 in FIG. 5 makes clear, and it then subsides to the transformed spark voltage of the ignition spark. In FIG. 5, in characteristic curve 46, once again the voltage jump at time point t₃ is indicated in response to the clamping voltage of switching means 30. Subsequently, there occurs once again a subsiding to the transformed spark voltage of the ignition spark.

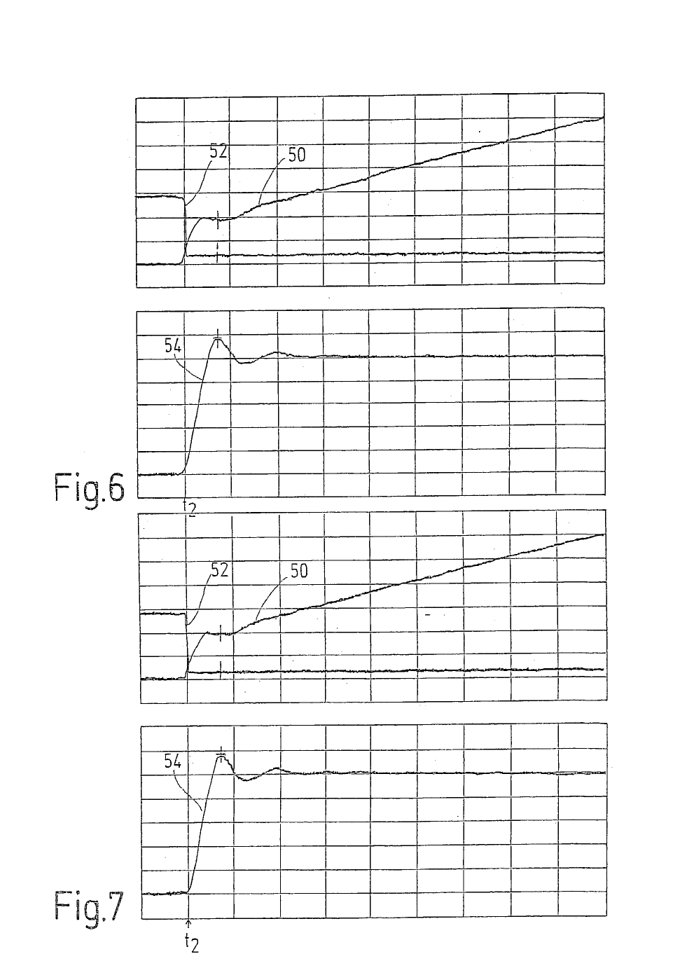

In FIGS. 6 and 7, the curve of switch-on voltage U_{CE} (characteristic curve 50), the curve of switch-on current I_{C} (characteristic curve 52) of switching means 30, and the curve of the secondary voltage (characteristic curve 54) of ignition coil 14 are compared in the case of a standard ignition system (FIG. 6) and in the case of double-coil ignition system 10 according to the present invention (FIG. 7). It is clear that in double-coil ignition system 10, switch-on voltage U_{CE} has the same curve and the same stroke as in the case of known ignition systems. To avoid so-called switch-on sparks when switching means 30 is switched on, high-voltage diodes are used in the known ignition systems. In double ignition system 10 according to the present invention, as a result of coupling the secondary sides of both ignition coils 14 and 16, high-voltage diodes of this type cannot be used. For this purpose, separate circuit arrangements can be used that are generally known for reducing voltage and are not depicted in any greater detail in the Figures.

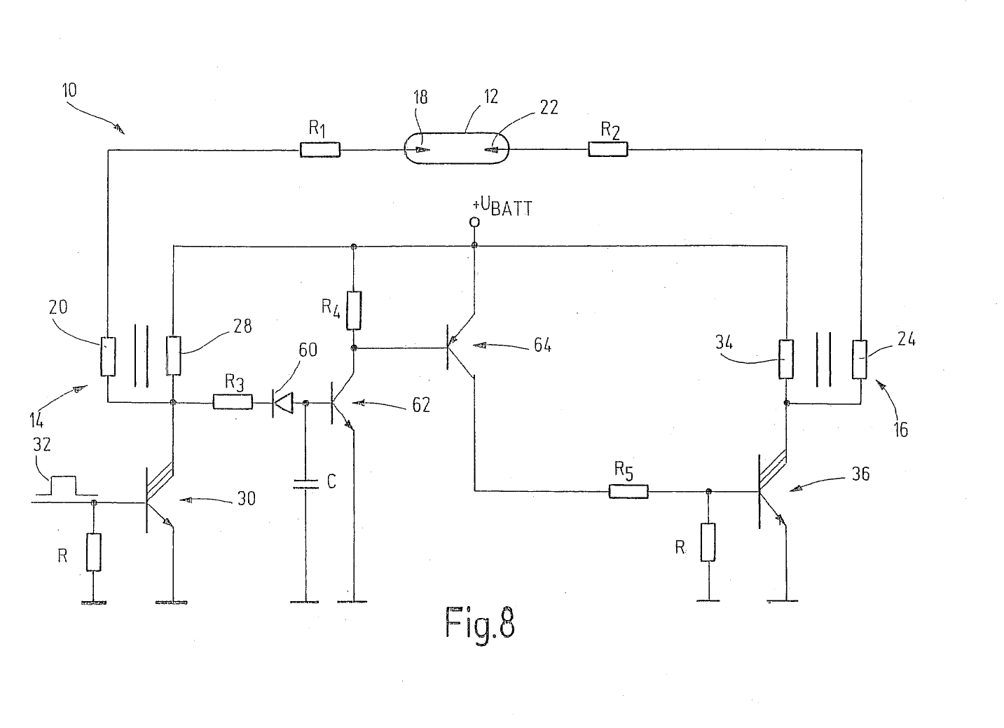

In FIG. 8, a transformed circuit arrangement of ignition system 10 is depicted. The identical parts as in FIG. 1 are provided with identical reference numerals and are not discussed once again.

The difference with respect to the circuit variant depicted in FIG. 1 lies in the fact that here second switching means 36 is not actuated via a control signal 38 from the drive circuit, but rather switching means 36 is turned on as a function of the spark voltage of the ignition spark of spark plug 12. For this purpose, the collector of switching means 30 is connected via a resistor R₃ to the cathode of a Zener diode 60. The anode of Zener diode 60 is connected, on the one hand, to the base of a transistor 62 and, on the other hand, to a first terminal of a capacitor C, whose other terminal is connected to ground. The emitter of transistor 62 is also connected to ground, whereas the collector of transistor 62 is connected to the base of a further transistor 64 and to a resistor R₄. An emitter of transistor 64 is connected to supply voltage U_{BATT}, whereas the collector of transistor 64 is connected via a resistor R₅ to the base of switching means 36 (Darlington ignition). A breakdown voltage of Zener diode 60 is, for example, 20 V.

Achieved by the circuit arrangement depicted in FIG. 8 is that transistor 62 is driven by the transformed spark voltage of the ignition spark when it exceeds the breakdown voltage of Zener diode 60, which is here 20 V. Resistor R₃, in this context, acts as a current-limiting resistor. If transistor 62 is switched through, then it connects transistor 64, which subsequently connects supply voltage U_{BATT} to the base of switching means 36, so that the latter is also switched through. In this context, capacitor C acts to dampen the emitter-base path of transistor 62 due to the fluctuating spark voltage, which is applied at the base of transistor 62.

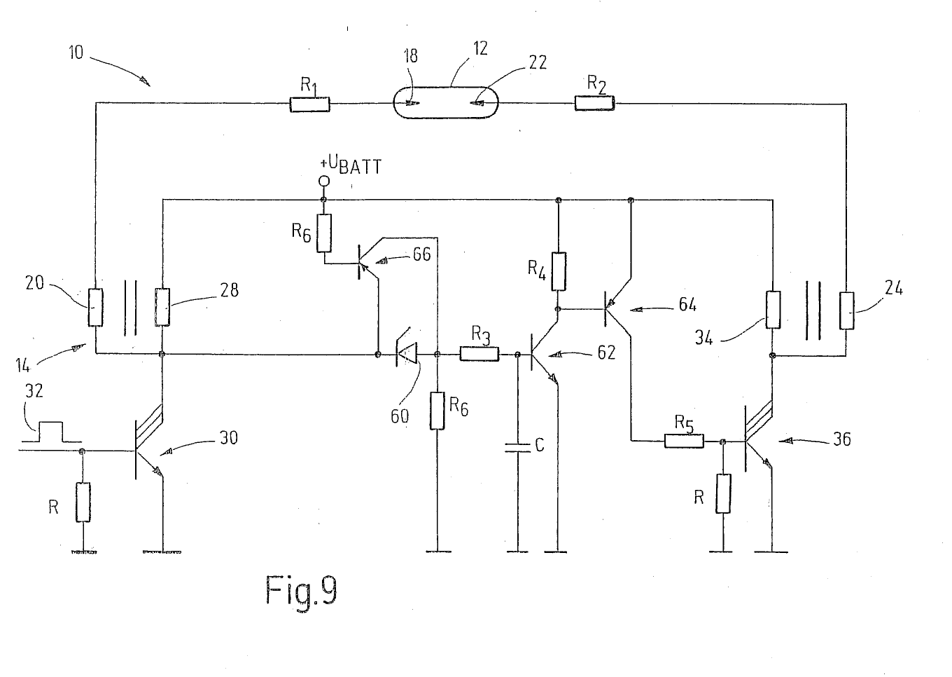

FIG. 9 depicts a circuit variant that is transformed in comparison to FIG. 8, in which the collector of switching means 30 is connected to the cathode of a Zener diode 60′. At the same time, the collector of switching means 30 is connected to an emitter terminal of a transistor 66, whose collector is connected via a resistor R₃ to the base of transistor 62. In addition, the collector of transistor 66 is connected via a resistor R₆ to ground. The base of transistor 66 is connected via a resistor R₆ to supply voltage U_{BATT}.

As a result of the circuit arrangement depicted in FIG. 9, transistor 62 is switched through, if the transformed spark voltage rises above supply voltage U_{BATT}. Resistors R₆ function as highly resistive protective resistors for transistor 62 in response to the clamping of switching means 30. Zener diode 60′ has a breakdown voltage of, for example, 50 V, so that the maximum collector-emitter voltage of transistor 66 is limited.

In the circuit variant depicted in FIGS. 1, 8, and 9, the assumption has been made that spark plug 12 has two electrodes 18 and 22, that are insulated against each other and are arranged so as to be insulated with respect to ground.

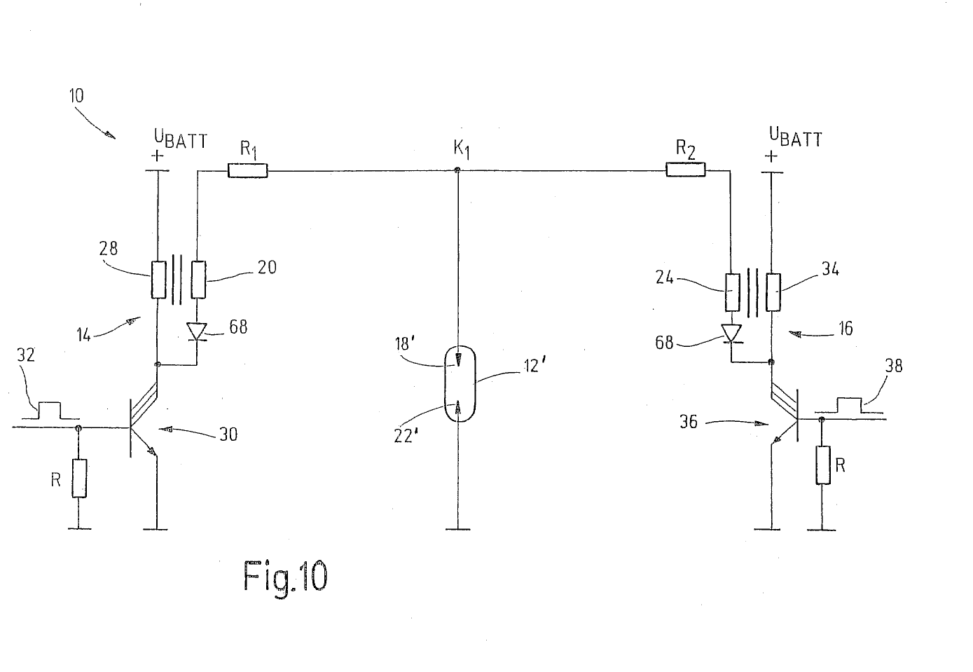

Standard spark plugs 12′ are known to have an electrode 18′, that emerges in an insulated fashion, and a ground electrode 22′. FIG. 10 depicts a circuit arrangement of ignition system 10, in which a spark plug 12′ having a ground electrode can also be used in a double-coil ignition system. In this context, electrode 18′ of spark plug 12′ is connected to a nodal point K₁, which is connected, on the one hand, via resistor R₁ to secondary winding 20 of first ignition coil 14 and, on the other hand, via resistor R₂ to secondary winding 24 of second ignition coil 16. In this circuit variant, it is possible in each case for a high-voltage diode 68 to be connected to the secondary circuit of ignition coils 14 and 16, which function to suppress the so-called switch-on ignition spark. Finally, the functioning of circuit arrangement 10 according to FIG. 10 can be compared to the switching arrangements that have already been discussed.

Switching means 30, 36 as well as the optionally present further switching components can be integrated into one monolithic component.

What is claimed is:

1. An ignition system for an internal combustion engine having an ignition device which requires a high voltage (ignition voltage) in order to ignite an ignition spark,
characterized by two ignition coils (14 and 16), whose secondary windings (20, 24) are each connected to electrodes (18, 22) of a spark plug (12, 12′), whose primary windings (28, 34) can each be connected via a switching means (30, 36) to a supply voltage source, and a drive circuit, via which the ignition coils (14, 16) are driven in a time-displaced manner.

2. The ignition system as recited in claim 1,
wherein the switching means (30, 36) are Darlington transistors.

3. The ignition system as recited in one of the preceding claims,
wherein each of the secondary windings (20, 24) is connected to one of the electrodes (18, 22) of the spark plug (12).

4. The ignition system as recited in one of claims 1 and 2, wherein the secondary windings (20, 24) are connected to an electrode (18′) of the spark plug (12′), and the other electrode (22′) of the spark plug (12′) is connected to ground.

5. The ignition system as recited in one of the preceding claims,
wherein control signals (32, 38) of the switching means (30, 36) are made available from an external drive circuit (engine control device).

6. The ignition system as recited in one of claims 1 through 4,
wherein the control signal (32) for the switching means (30) is made available from the external drive circuit, and the control signal (38) for the switching means (36) is made available as a function of an operating parameter of the ignition system (10).

7. The ignition system as recited in claim 6,
wherein the control signal (38) is made available in response to exceeding a specifiable spark voltage of the ignition spark of the spark plug (12, 12′).

8. The ignition system as recited in one of claims 6 and 7, wherein the specifiable spark voltage is determined by the breakdown voltage of a Zener diode (60).

9. The ignition system as recited in one of claims 6 and 7, wherein the specifiable spark voltage is determined by the level of a supply voltage (U_{BATT}).
